(19) United States
(12) Patent Application Publication
(10) Pub. No.: US 2016/0307542 A1
(43) Pub. Date: Oct. 20, 2016

(54) Distributed Light Sensors for Ambient Light Detection

(71) Applicant: Apple Inc., Cupertino, CA (US)

(72) Inventors: Dong Zheng, San Jose, CA (US); Brian R. Land, Woodside, CA (US)

(21) Appl. No.: 15/194,158

(22) Filed: Jun. 27, 2016

Related U.S. Application Data
(63) Continuation of application No. 13/241,034, filed on Sep. 22, 2011, now abandoned.

(51) Int. Cl. G09G 5/10; G06F 3/044; G06F 3/041; G01J 1/32; G01J 1/42

(52) U.S. Cl. CPC G09G 5/10; G01J 1/32; G01J 1/4204; G06F 3/0412; G06F 3/044; G09G 2360/144; G09G 2320/0626

(57) ABSTRACT

An electronic device may have a display with a brightness that is adjusted based on ambient light data from multiple ambient light sensors. Sensors that are shadowed can be ignored. A touch sensor array in the display may have electrodes that overlap ambient light sensors. When a touch sensor signal indicates that an external object is covering one of the ambient light sensors, data from that ambient light sensor can be discarded. The ambient light sensors may include a primary ambient light sensor such as a human-eye-response ambient light sensor and may include an array of secondary ambient light sensors such as non-human-eye-response sensors. The secondary ambient light sensors may be formed on a display layer such as a thin-film-transistor layer and may be formed from thin-film materials. An algorithm may be used to dynamically calibrate non-human-eye-response ambient light sensors to the human-eye-response ambient light sensor.

This application is a continuation of patent application Ser. No. 13/241,034, filed Sep. 22, 2011, which is hereby incorporated by reference herein in its entirety.

### BACKGROUND

This relates to sensors and, more particularly, to ambient light sensors for electronic devices.

Cellular telephones and other portable devices with displays such as tablet computers sometimes contain ambient light sensors. An ambient light sensor can detect when a portable device is in a bright light environment. For example, an ambient light sensor can detect when a portable device is exposed to direct sunlight. When bright light is detected, the portable device can automatically increase the brightness level of the display to ensure that images on the display remain visible and are not obscured by the presence of the bright light. In dark surroundings, the display brightness level can be reduced to save power and provide a comfortable reading environment.

If care is not taken, an ambient light sensor in a cellular telephone can be shadowed by an external object such as part of a user's body. When the ambient light sensor is shadowed, the ambient light sensor may not make accurate ambient light readings and the display brightness in the cellular telephone may not be adjusted properly.

It would therefore be desirable to be able to provide improved ambient light sensor systems for electronic devices.

### SUMMARY

An electronic device may have an adjustable electronic component such as a display with an adjustable brightness. Storage and processing circuitry in the electronic device may be used to gather ambient light data from ambient light sensors and may be used to control an adjustable electronic component accordingly. For example, an electronic device may use ambient light data to adjust the display brightness. Ambient light data may be gathered by multiple ambient light sensors. The device may process ambient light sensor data gathered using the multiple ambient light sensors to determine which ambient light sensor data best represents current ambient lighting conditions for the electronic device. Sensors that are shadowed due to the presence of a user's body or other external object can be ignored.

During sensor data processing operations, the device can discard low ambient light signal readings or other readings that appear to be erroneous due to shadowing. Sensor structures that detect the proximity of external objects may also be used in determining whether a given sensor has been shadowed. For example, in a device with a touch sensitive display, a touch sensor array in the display may have electrodes that overlap ambient light sensors. When a touch sensor signal indicates that an external object is covering one of the ambient light sensors, data from that ambient light sensor can be discarded.

The ambient light sensors may include a primary ambient light sensor such as a human-eye-response ambient light sensor and may include an array of secondary ambient light sensors such as non-human-eye-response sensors. The secondary ambient light sensors may be located on a display layer such as a thin-film-transistor layer and may be formed from deposited thin-film materials such as nanocrystal silicon (silicon-rich silicon oxide), amorphous silicon, or polysilicon. Secondary ambient light sensors may also be formed from separate light sensor structures such as integrated circuit light sensor structures bonded to the display layer or other support structure or light sensor structures formed from discrete packaged photodiodes that are bonded to a display layer or other support structure.

Readings from the primary ambient light sensor and processed readings from one or more of the secondary ambient light sensors may be compared to determine whether to use primary ambient light sensor data or secondary ambient light sensor data. If the primary ambient light sensor is shadowed, data from the secondary ambient light sensors may be used in adjusting the display or taking other suitable actions in the device. If the primary ambient light sensor is not shadowed, data from the primary ambient light sensor may be used in controlling the display brightness. Primary ambient light sensor data may also be used in calibrating the secondary ambient light sensors or taking other suitable actions.

Further features of the invention, its nature and various advantages will be more apparent from the accompanying drawings and the following detailed description of the preferred embodiments.

### BRIEF DESCRIPTION OF THE DRAWINGS

FIG. 1 is a perspective view of an illustrative electronic device with ambient light sensor structures in accordance with an embodiment of the present invention.

FIG. 2 is a schematic diagram of an illustrative electronic device with ambient light sensor structures in accordance with an embodiment of the present invention.

FIG. 3 is a cross-sectional side view of an illustrative electronic device having a display layer such as a thin-film-transistor layer with ambient light sensor structures in accordance with an embodiment of the present invention.

FIG. 4 is a perspective view of illustrative display structures such as a thin-film transistor layer with ambient light sensors and an associated color filter layer in accordance with an embodiment of the present invention.

FIG. 5 is a top view of illustrative display structures with ambient light sensors in accordance with an embodiment of the present invention.

FIG. 6 is a circuit diagram showing how switching circuitry may be used to allow multiple ambient light sensors to share a signal path that feeds a common analog-to-digital converter in accordance with the present invention.

FIG. 7 is a flow chart of illustrative steps involved in processing and using ambient light sensor signals from multiple ambient light sensors in accordance with an embodiment of the present invention.

### DETAILED DESCRIPTION

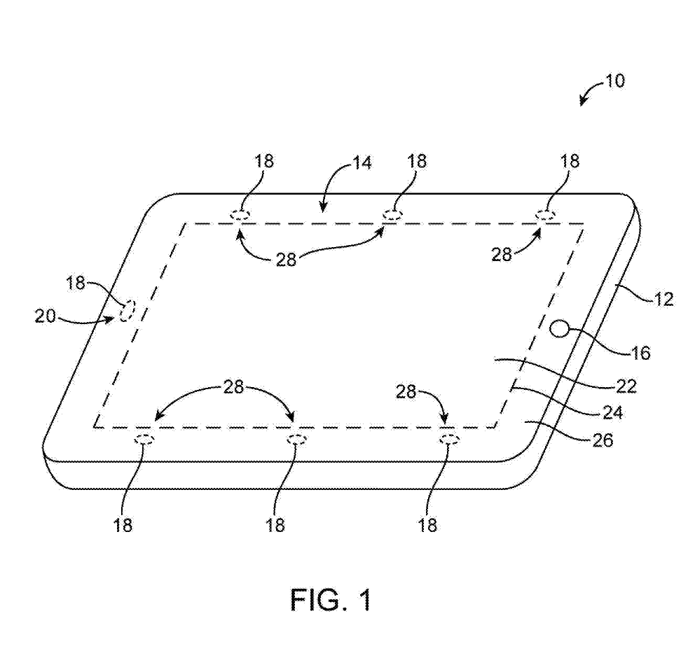

Electronic devices such as device 10 of FIG. 1 may be provided with an ambient light sensor system. The ambient light sensor system may use readings from ambient light sensors to determine the brightness level of the environment ambient. Ambient brightness level information may be used by the electronic device in controlling display brightness. For example, in response to determining that ambient light levels are high, an electronic device may increase display brightness to ensure that images on the display remain visible to the user.

Device 10 of FIG. 1 may be a portable computer, a tablet computer, a computer monitor, a handheld device, global positioning system equipment, a gaming device, a cellular telephone, portable computing equipment, or other electronic equipment.

Device 10 may include a housing such as housing 12. Housing 12, which may sometimes be referred to as a case, may be formed of plastic, glass, ceramics, fiber composites, metal (e.g., stainless steel, aluminum, etc.), other suitable materials, or a combination of these materials.

Housing 12 may be formed using an unibody configuration in which some or all of housing 12 is machined or molded as a single structure or may be formed using multiple structures (e.g., an internal frame structure, one or more structures that form exterior housing surfaces, etc.).

In some configurations, housing 12 may be formed using front and rear housing structures that are substantially planar. For example, the rear of device 10 may be formed from a planar housing structure such as a planar glass member, a planar plastic member, a planar metal structure, or other substantially planar structure. The edges (sidewalls) of housing 12 may be straight (vertical) or may be curved (e.g., housing 12 may be provided with sidewalls formed from rounded extensions of a rear planar housing wall).

As shown in FIG. 1, the front of device 10 may include a planar display such as display 14. The surface of display 14 may be covered with a planar cover layer. The cover layer may be formed from a layer of clear glass, a layer of clear plastic, or other transparent materials (e.g., materials that are transparent to visible light and that are generally transparent to infrared light). The cover layer that covers display 14 may sometimes be referred to as a display cover layer, display cover glass, or plastic display cover layer.

Display 14 may, for example, be a touch screen that incorporates capacitive touch electrodes or a touch sensor formed using other types of touch technology (e.g., resistive touch, light-based touch, acoustic touch, force-sensor-based touch, etc.). Display 14 may include image pixels formed from light-emitting diodes (LEDs), organic LEDs (OLEDs), plasma cells, electronic ink elements, liquid crystal display (LCD) components, or other suitable image pixel structures.

Display 14 and the cover layer on display 14 may have an active region and an inactive region. Active region 22 of display 14 may lie within rectangular boundary 24. Within active region 22, display pixels such as liquid crystal display pixels or organic light-emitting diode display pixels may display images for a user of device 10. Active display region 22 may be surrounded by an inactive region such as inactive region 26. Inactive region 26 may have the shape of a rectangular ring surrounding active region 22 and rectangular boundary 24 (as an example). To prevent a user from viewing internal device structures under inactive region 26, the underside of the cover layer for display 14 may be coated with an opaque masking layer in inactive region 26. The opaque masking layer may be formed from a layer of ink (e.g., black or white ink or ink of other colors), a layer of plastic, or other suitable opaque masking material.

Device 10 may include input-output ports, buttons, sensors, status indicator lights, speakers, microphones, and other input-output components. As shown in FIG. 1, for example, device 10 may include one or more openings in inactive region 26 of display 14 to accommodate buttons such as button 16. Device 10 may also have openings in other portions of display 14 and/or housing 12 to accommodate input-output ports, speakers, microphones, and other components.

Ambient light sensors may be mounted at any locations within device 10 that are potentially exposed to ambient light. For example, one or more ambient light sensors may be mounted behind openings or other windows in housing 12 (e.g., clear windows or openings in a metal housing, clear windows or openings in a plastic housing, etc.). With one suitable arrangement, one or more ambient sensors in device 10 may be mounted under portions of display 14. For example, one or more ambient light sensors may be mounted under a display cover layer in inactive region 26 of display 14, as shown by illustrative ambient light sensor locations 18 in FIG. 1.

Ambient light sensors may be mounted under ambient light sensor windows in the opaque masking layer in inactive region 26 or may be mounted in other locations in device 10 that are exposed to ambient light. In configurations in which ambient light sensors are mounted under region 26 of display 14, ambient light sensor windows for the ambient light sensors may be formed by creating circular holes or other openings in the opaque masking layer in region 26. Ambient light sensor windows may also be formed by creating localized regions of material that are less opaque than the remaining opaque masking material or that otherwise are configured to allow sufficiently strong ambient light signals to be detected. For example, ambient light sensor windows may be created by locally thinning portions of an opaque masking layer or by depositing material in the ambient light sensor windows that is partly transparent. During operation, ambient light from the exterior of device 10 may pass through the ambient light sensor windows to reach associated ambient light sensors in the interior of device 10.

One or more different types of ambient light sensors may be used in gathering ambient light sensor data for device 10. Ambient light sensors that may be used in device 10 include discrete silicon light sensors, discrete sensors based on other semiconductors, multiple sensors that have been integrated using a common substrate, amorphous silicon sensors, polysilicon sensors, and nanocrystal sensors (as examples). Nanocrystal sensors, which are sometimes referred to as silicon-rich silicon dioxide sensors, may be formed from clumps of silicon embedded in a dielectric matrix such as a silicon dioxide layer. Quantum tunneling effects may allow carriers to move within the nanocrystal sensor material. These are merely illustrative types of sensors that may be formed in device 10. In general, any suitable components in device 10 that can detect ambient light levels may be used in forming ambient light sensors for device 10.

The presence of infrared light and other light outside of the visible portion of the light spectrum may potentially disrupt accurate operation of ambient light sensors. This is because only light that is visible to the human eye will generally affect the need for changes to display brightness. Infrared light brightness in the ambient environment will generally not be detectable by the eye of a user, so infrared light brightness levels generally do not affect how bright a display should be to clearly display images to the user. To ensure an accurate human eye response, it may be desirable to provide one or more of the ambient light sensors in device 10 with optical filters. Device 10 may, for example, be provided with one or more discrete packaged human-eye-response ambient light sensors. A discrete packaged human-eye-response ambient light sensor may include two sensor elements. A first of the two sensor elements may be used to gather visible and infrared light. A second of the two sensor elements may have a filter that blocks visible light and may therefore be used to gather infrared light signals. Visible light data from the ambient light sensor may be produced by subtracting the data from second sensor element from that of the first sensor element. Other types of human-eye-response ambient light sensor may be used if desired (e.g., sensors with infrared-light-blocking filters, etc.). The use of a human-eye-response ambient light sensor having multiple sensor elements tuned to gather light readings from different portions of the light spectrum is merely illustrative.

A human-eye-response ambient light sensor may be installed in a location such as location 20 (e.g., in alignment with an ambient light sensor window in the opaque masking layer in region 26). Although a configuration in which there is a single human-eye-response ambient light sensor in region 20 of device 10 is sometimes described as an example, there may, in general, be any suitable number of human-eye-response ambient light sensors in device 10 (e.g., one or more, two or more, three or more, four or more, six or more, or ten or more). The configuration in which there is a single human-eye-response ambient light sensor in device 10 is merely illustrative.

It may not always be desirable to incur the cost associated with ensuring that an ambient light sensor has a human eye response. Rather, it may be desirable to include one or more non-human-eye-response ambient light sensors in device 10 to help reduce device cost and complexity. Sensors of this type may be provided in locations such as locations 28 (e.g., in alignment with respective ambient light sensor windows in the opaque masking layer in region 26). There may be one or more, two or more, three or more, four or more, five or more, or six or more non-human-eye-response sensors in device 10. A configuration in which there are six non-human-eye-response ambient light sensors in device 10 is sometimes described herein as an example.

If desired, other mounting locations for the ambient light sensors and other types of ambient light sensors may be used. For example, most or all of the ambient light sensors in device 10 may be human-eye-response ambient light sensors, all of the ambient light sensors may be non-human-eye-response sensors, etc. The mounting of a human-eye-response ambient light sensor in region 20 and six non-human-eye-response sensors in regions 28 is merely illustrative.

In configurations in which there are more than one ambient light sensor in device 10, one of the sensors may be used as a main or primary ambient light sensor and one or more additional sensors may serve as secondary ambient light sensors. For example, a human-eye-response sensor in a location such as location 20 of FIG. 1 may serve as the main ambient light sensor and non-human-eye response sensors in locations 28 may serve as secondary ambient light sensors. In this type of arrangement, device 10 may be configured to use ambient light readings from the main ambient light sensor unless it is determined that the main ambient light sensor is being shadowed by a user's body or other external object. If a shadowing situation is detected, the device may resort to use of ambient light sensor data gathered by one or more of the secondary ambient light sensors.

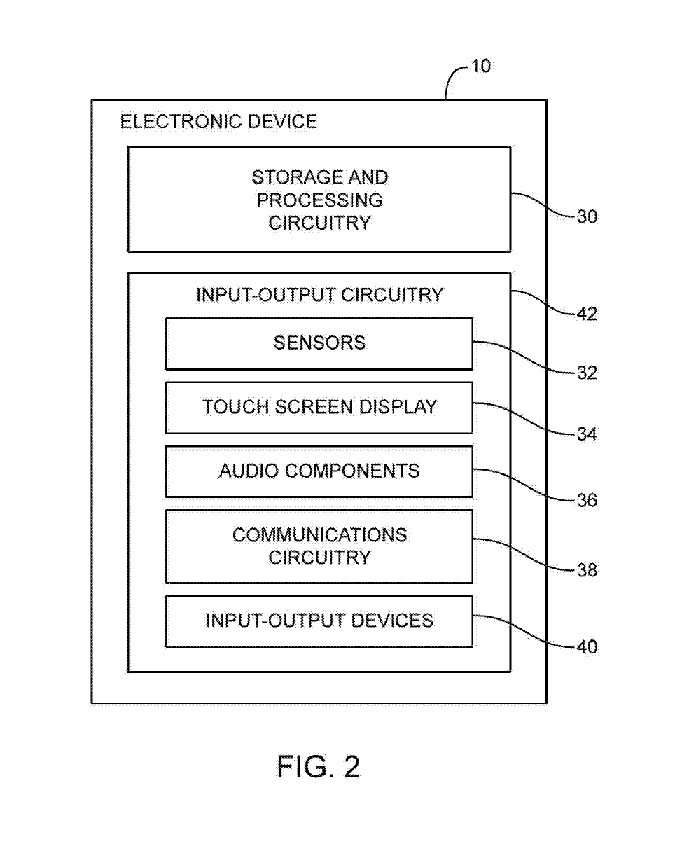

A schematic diagram of an illustrative electronic device such as electronic device 10 of FIG. 1 is shown in FIG. 2. As shown in FIG. 2, electronic device 10 may include control circuitry such as storage and processing circuitry 30. Storage and processing circuitry 30 may include storage such as hard disk drive storage, nonvolatile memory (e.g., flash memory or other electrically-programmable-read-only memory configured to form a solid state drive), volatile memory (e.g., static or dynamic random-access-memory), etc. Processing circuitry in storage and processing circuitry 30 may be used to control the operation of device 10. This processing circuitry may be based on one or more microprocessors, microcontrollers, digital signal processors, baseband processors, power management units, audio codec chips, application specific integrated circuits, display driver integrated circuits, etc.

Storage and processing circuitry 30 may be used to run software on device 10 such as internet browsing applications, voice-over-internet-protocol (VOIP) telephone call applications, email applications, media playback applications, operating system functions, etc. The software may be used to implement control operations such as real time display brightness adjustments or other actions taken in response to measured ambient light data. Circuitry 30 may, for example, be configured to implement a control algorithm that controls the gathering and use of ambient light sensor data from ambient light sensors located in regions such as regions 20 and 28 of FIG. 1 (e.g., ambient light sensor data from a primary ambient light sensor and one or more secondary ambient light sensors or other suitable set of ambient light sensors).

Input-output circuitry 42 may be used to allow data to be supplied to device 10 and to allow data to be provided from device 10 to external devices. Input-output circuitry 42 may include sensors 32. Sensors 32 may include ambient light sensors, proximity sensors, touch sensors (e.g., capacitive touch sensors that are part of a touch screen display or that are implemented using stand-alone touch sensor structures), accelerometers, and other sensors.

Input-output circuitry 42 may also include one or more displays such as display 34. Display 34 may be a liquid crystal display, an organic light-emitting diode display, an electronic ink display, a plasma display, a display that uses other display technologies, or a display that uses any two or more of these display configurations. Display 34 may include an array of touch sensors (i.e., display 34 may be a touch screen). The touch sensors may be capacitive touch sensors formed from an array of transparent touch sensor electrodes such as indium tin oxide (ITO) electrodes or may be touch sensors formed using other touch technologies (e.g., acoustic touch, pressure-sensitive touch, resistive touch, etc.).

Audio components 36 may be used to provide device 10 with audio input and output capabilities. Examples of audio components that may be included in device 10 include speakers, microphones, buzzers, tone generators, and other components for producing and detecting sound.

Communications circuitry 38 may be used to provide device 10 with the ability to communicate with external equipment. Communications circuitry 38 may include analog and digital input-output port circuitry and wireless circuitry based on radio-frequency signals and/or light.

Device 10 may also include a battery, power management circuitry, and other input-output devices 40. Input-output devices 40 may include buttons, joysticks, click wheels, scrolling wheels, touch pads, key pads, keyboards, cameras, light-emitting diodes and other status indicators, etc.

A user can control the operation of device 10 by supplying commands through input-output circuitry 42 and may receive status information and other output from device 10 using the output resources of input-output circuitry 42. Using ambient light sensor readings from one or more ambient light sensors in sensors 32, storage and processing circuitry 30 can automatically take actions in real time such as adjusting the brightness of display 34, adjusting the brightness of status indicator light-emitting diodes in devices 40, adjusting the colors or contrast of display 34 or status indicator lights, etc.

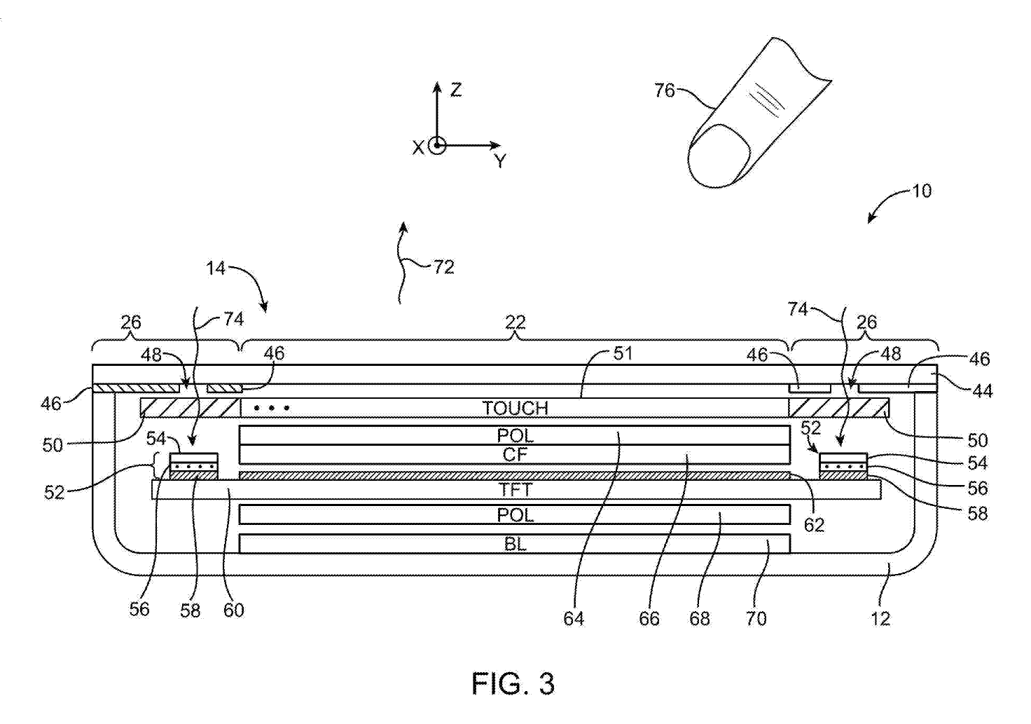

FIG. 3 is a cross-sectional side view of device 10. As shown in FIG. 3, device 10 may include a display such as display 14. Display 14 (in the FIG. 3 example) may have a cover layer such as cover layer 44. Cover layer 44 may be formed from a layer of glass, a layer of plastic, or other transparent material. If desired, the functions of cover layer 44 may be performed by other display layers (e.g., polarizer layers, anti-scratch films, color filter layers, etc.). The arrangement of FIG. 3 is merely illustrative.

Display structures that are used in forming images for display 14 may be mounted under active region 22 of display 14. In the example of FIG. 3, display 14 has been implemented using liquid crystal display structures. If desired, display 14 may be implemented using other display technologies. The use of a liquid crystal display in the FIG. 3 example is merely illustrative.

The display structures of display 14 may include a touch sensor array such as touch sensor array 51 for providing display 14 with the ability to sense input from an external object such as external object 76 when external object 76 is in the vicinity of a touch sensor on array 51. With one suitable arrangement, touch sensor array 51 may be implemented on a clear dielectric substrate such as a layer of glass or plastic and may include an array of indium tin oxide electrodes or other clear electrodes such as electrodes 50. The electrodes may be used in making capacitive touch sensor measurements.

Display 14 may include a backlight unit such as backlight unit 70 for providing backlight 72 that travels vertically upwards in dimension Z through the other layers of display 14. The display structures may also include upper and lower polarizers such as lower polarizer 68 and upper polarizer 64. Color filter layer 66 and thin-film transistor layer 60 may be interposed between polarizers 68 and 64. A layer of liquid crystal material may be placed between color filter layer 66 and thin-film transistor layer 60.

Color filter layer 66 may contain a pattern of colored elements for providing display 14 with the ability to display colored images. Thin-film transistor layer 60 may include pixel structures for applying localized electric fields to the liquid crystal layer. The localized electric fields may be generated using thin-film transistors and associated electrodes. The electrodes and other conductive structures on thin-film transistors layer 60 may be formed from metal (e.g., aluminum) and transparent conductive material such as indium tin oxide. In the FIG. 3 example, thin-film transistors (e.g., polysilicon transistors) and associated conductive patterns are shown as structures 62.

Indium tin oxide traces or other conductive patterned traces that are formed on thin-film transistor layer 60 may also be used in forming parts of ambient light sensors 52. For example, a lower electrode in each ambient light sensor 52 may be formed from an indium tin oxide trace or metal trace such as trace 58. Ambient light sensors 52 in the example of FIG. 3 may also include nanocrystal silicon layers such as layers 56 and upper electrodes 54 (e.g., an upper electrode formed from indium tin oxide). Sensors 52 may be implemented using elongated rectangular sensor shapes that run parallel to the edges of device 10. These shapes may allow sensors 52 to gather sufficient light for operation without requiring the use of undesirably large borders for display 14.

An opaque masking layer such as opaque masking layer 46 may be provided in inactive region 26. The opaque masking layer may be used to block internal device components from view by a user through peripheral edge portions of clear display cover layer 44. The opaque masking layer may be formed from black ink, black plastic, plastic or ink of other colors, metal, or other opaque substances. Ambient light sensor windows such as windows 48 may be formed in opaque masking layer 46. For example, circular holes or openings with other shapes may be formed in layer 46 to serve as ambient light sensor windows 48. Ambient light sensor windows 48 may, if desired, be formed in locations such as locations 18 of FIG. 1.

As shown in FIG. 3, ambient light sensors 52 may be implemented using thin-film nanocrystal sensor structures, thin-film amorphous silicon sensor structures, thin-film polysilicon sensor structures, or other thin-film semiconductor sensor structures that have been deposited on a display layer in display 14 under ambient light sensor windows 48. Ambient light sensors 52 may also be implemented using discrete silicon sensors. Ambient light sensors 52 such as the ambient light sensors of FIG. 3 may serve as secondary ambient light sensors for device 10. If desired, one of ambient light sensors 52 may serve as a primary ambient light sensor for device 10.

During operation of device 10, ambient light 74 may pass through ambient light sensor windows 48 and may be detected using ambient light sensors 52. Signals from ambient light sensors 52 may be routed to analog-to-digital converter circuitry on thin-film-transistor layer 60 and/or other control circuitry in device 10 such as one or more integrated circuits in storage and processing circuitry 30 of FIG. 2 (e.g., integrated circuits containing analog-to-digital converter circuitry for digitizing analog ambient light sensor signals from sensors 52). If desired, an ambient light sensor (e.g., an ambient light sensor implemented on an integrated circuit) may be provided with built-in analog-to-digital converter circuitry and communications circuitry so that digital light sensor signals can be routed to a processor using a serial interface or other digital communications path.

Ambient light sensor signal routing paths on thin-film-transistor layer 60 may be formed using indium tin oxide conductors or other conductive paths formed on the upper surface of thin-film-transistor layer 60 (as examples). By depositing thin-film ambient light sensors 52 on structures in device 10 such as display layers (e.g., thin-film-transistor substrate layer 60), the cost of implementing multiple ambient light sensors within device 10 may be minimized. It may therefore be practical to include six sensors 52 (or other suitable number of sensors 52) within device 10. When multiple ambient light sensors are used in device 10, the likelihood of inadvertently shadowing all sensors simultaneously may be decreased and the likelihood of gathering an accurate ambient light sensor reading may therefore be increased.

The presence of an external object may shadow an ambient light sensor sufficiently that the ambient light sensor does not produce an ambient light sensor reading that accurately reflects the level of ambient light surrounding device 10. If a user places a finger or other external object such as external object 76 in the vicinity of an ambient light sensor, it may therefore be desirable to ignore the reading obtained with that ambient light sensor. Shadowing conditions can be detected by observing whether a sensor (e.g., one of secondary sensors 52) has a reading that is significantly lower than other sensors. If a low light level is detected, data from that sensor can be discarded.

Supplemental sensors may also be used to detect shadowing conditions. For example, a capacitive touch sensor electrode or a light-based proximity sensor that emits infrared light and detects corresponding reflected infrared light may be used to determine when an external object such as object 76 is in the vicinity of an ambient light sensor. When close proximity of object 76 is detected, sensor data from a nearby sensor may be ignored. As an example, one or more sensor electrodes such as capacitive sensor electrodes 50 of sensor array 51 may overlap ambient light sensors 52 or may otherwise be located in the vicinity of ambient light sensors 52. In this type of arrangement, capacitive sensor readings from electrodes 50 may be used to determine whether object 76 is located close to sensors 52. If a touch event is detected by a given one of sensor electrodes 50, data from the ambient light sensor that is located adjacent to that electrode may be ignored.

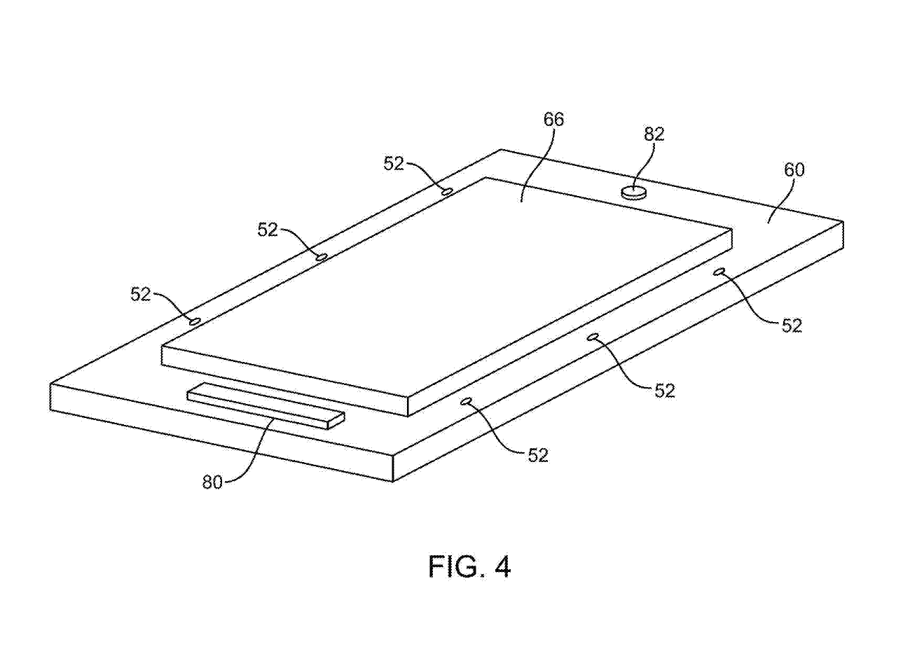

FIG. 4 is a perspective view of a thin-film-transistor layer and color filter layer that may be used in a display such as display 14 of FIG. 3. Color filter layer 66 and thin-film-transistor layer 60 may have different sizes. For example, the length and/or the width of thin-film-transistor layer 60 may be larger than the length and/or width of color filter layer 66, to create exposed ledges on which ambient light sensors and additional components such as display driver integrated circuit 80 may be mounted.

As shown in FIG. 4, an ambient light sensor such as primary ambient light sensor 82 may be mounted to the upper surface of thin-film-transistor layer 60 in a portion of thin-film-transistor layer 60 that is exposed and not covered by color filter layer 66. Primary ambient light sensor 82 may include silicon photosensitive structures that produce data that mimics a human eye response (i.e., sensor 82 may be a discrete packaged human-eye-response sensor). Primary ambient light sensor 82 may have terminals that are connected to indium tin oxide traces or other conductive traces on the surface of thin-film-transistor layer 60 using solder or conductive adhesive. If desired, primary ambient light sensor 82 may be mounted to a printed circuit such as a flexible printed circuit. The flexible printed circuit may be mounted to the upper surface of thin-film-transistor layer 60 so that sensor 82 is placed in a location such as the location shown in FIG. 4. Primary ambient light sensor 82 of FIG. 4 may be mounted under a corresponding ambient light sensor window in display cover layer 44 in a location such as location 20 of FIG. 1.

In addition to accommodating driver integrated circuit 80, traces for distributing display control signals ambient light sensor signals, and primary ambient light sensor 82, the exposed ledge that is formed by the laterally extended portions of thin-film-transistor layer 60 that are not covered by color filter layer 66 may be used to support secondary ambient light sensors. As shown in FIG. 4, for example, secondary ambient light sensors 52 may be formed on the surface of thin-film-transistor layer 60 along opposing sides of color filter layer 66. Thin-film-transistor layer 60 may be formed from a planar dielectric member such as a sheet of plastic or glass or other suitable substrate material. Secondary ambient light sensors 52 may be thin-film sensors that have been deposited and patterned on the glass or plastic layer. For example, secondary ambient light sensors 52 may be non-human-eye-response nanocrystal light sensors, non-human-eye-response amorphous silicon sensors, non-human-eye polysilicon light sensors, or other sensor structures that have been deposited on the surface of a display layer such as thin-film-transistor layer 60. Secondary ambient light sensors 52 may be formed on thin-film-transistor layer 60 in alignment with ambient light sensor windows in inactive region 26 of display 14 (e.g., in locations such as locations 28 of FIG. 1).

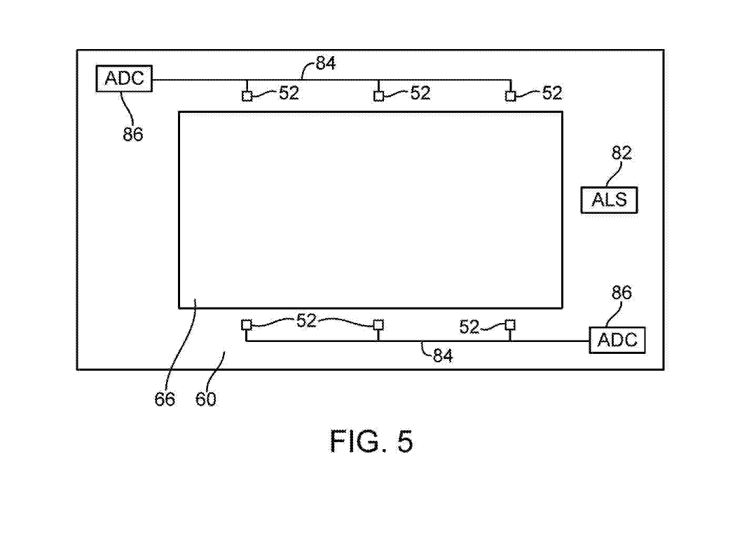

FIG. 5 is a top view thin-film-transistor layer 60 and color filter layer 66 of FIG. 4 showing how traces such as traces 84 may be used in gathering signals from ambient light sensors 52. Analog-to-digital control circuitry may be used in converting analog light sensor measurements from ambient light sensors 52 to corresponding digital ambient light sensor readings. Traces 84 may be, for example, indium tin oxide traces or metal traces on thin-film-transistor layer 60. Analog-to-digital converters 86 may be formed from thin film transistors on layer 60 or may be implemented in other storage and processing circuitry 30 (e.g., circuitry in a display driver integrated circuit or circuitry in another integrated circuit). Ambient light sensor data from primary ambient light sensor 82 may be provided to analog-to-digital converters 86 on thin-film-transistor layer 60 or may be provided to analog-to-digital converter circuitry elsewhere in device 10 (e.g., analog-to-digital converter circuitry in a display driver integrated circuit, etc.). Use of analog-to-digital converter circuitry that has been implemented on thin-film-transistor layer 60 may help minimize the distance signals must travel before being converted to digital data, thereby helping to reduce noise.

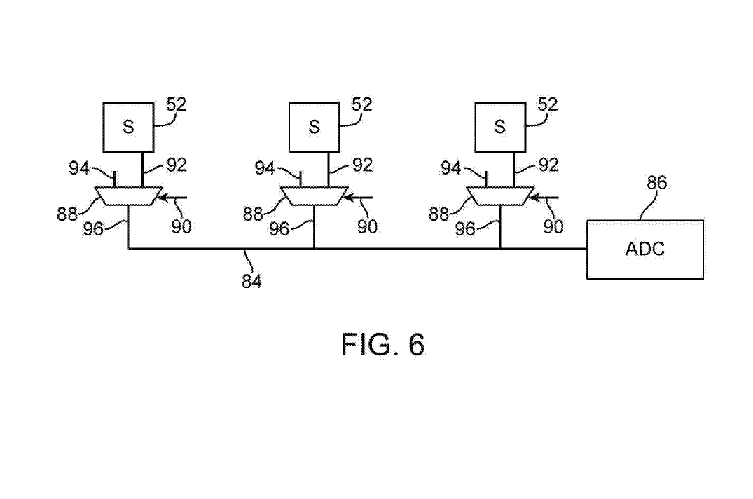

Ambient light sensor data signal lines such as lines 84 may be shared between multiple sensors using multiplexing circuitry of the type shown in FIG. 6. As shown in FIG. 6, multiple ambient light sensors 52 may be coupled to a common signal path such as path 84. Multiplexers 88 may each have a first input such as input 92 that receives the output of an associated one of ambient light sensors 52 and may each have a second input such as input 94. Inputs 94 may be floating or may be connected to a fixed reference voltage so as to reduce voltage swing during switching and thereby increase switching time. Each multiplexer 88 may have a control input such as control input 90. When it is desired to couple the output of a given ambient light sensor 52 to path 84 and analog-to-digital converter circuitry 86, storage and processing circuitry 30 (FIG. 2) can apply control signals to inputs 90. The control signals may couple the output from a desired sensor 52 to path 84 by coupling the multiplexer input 92 that is connected to that sensor to its multiplexer output 96 and path 84. All other multiplexers 88 coupled to path 84 may be instructed to couple their inactive inputs (floating inputs 94) to their outputs 96. By deactivating all but one of sensors 52 in this way, sensor data from one of sensors 52 at a time may be provided to analog-to-digital converter 86 using a single shared conductive path such as path 84.

In devices such as device 10 with multiple ambient light sensors, ambient light sensor data from multiple ambient light sensors may be gathered and processed by storage and processing circuitry 30. Ambient light sensor data from multiple secondary light sensors such as secondary ambient light sensors 52 in FIG. 5 may be gathered and ambient light sensor data from a primary ambient light sensor such as ambient light sensor 82 may be gathered. These ambient light signals may be processed to generate reliable ambient light sensor data. Using the processed and therefore reliable ambient light sensor data, storage and processing circuitry 30 may take suitable actions in controlling the operation of device 10. For example, storage and processing circuitry 30 may adjust the brightness of touch screen display 34 or may take other actions.

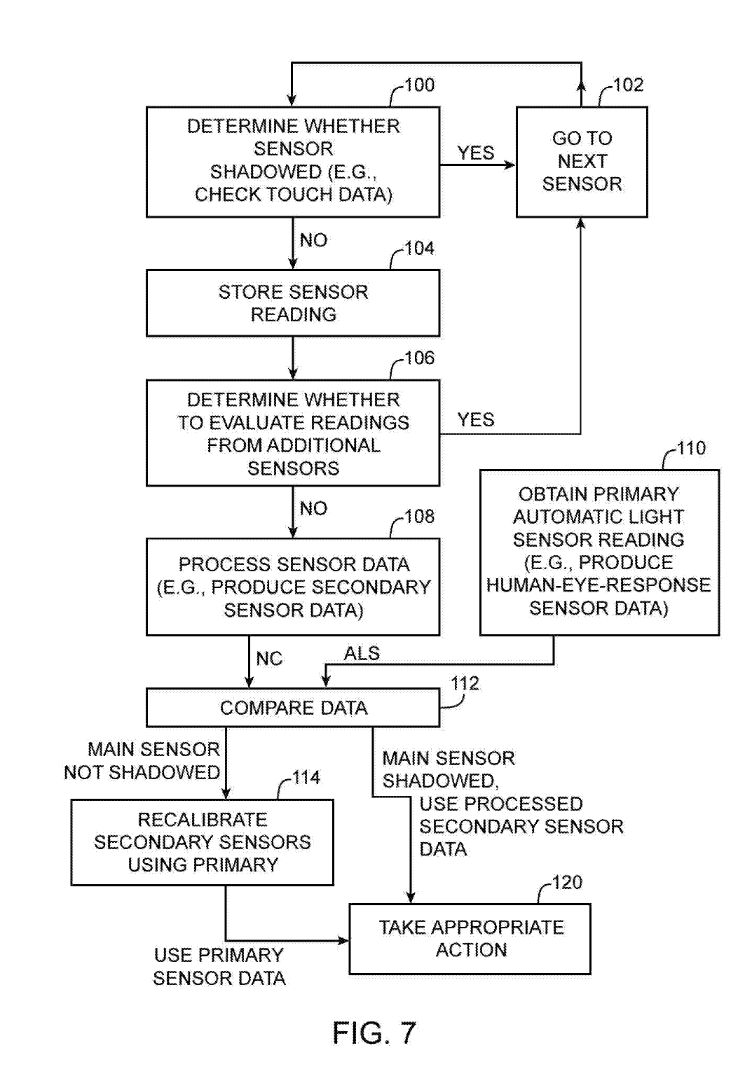

A flow chart of illustrative steps that may be used in controlling the operation of device 10 using ambient light sensors such as primary ambient light sensor 82 and secondary ambient light sensors 52 is shown in FIG. 7.

During the operations of step 100, 102, 104, 106, and 108, storage and processing circuitry 30 may be used to gather and analyze secondary ambient light sensor data from secondary ambient light sensors 52 and may be used to produce corresponding processed secondary ambient light sensor data. With one suitable arrangement, storage and processing circuitry 30 may gather signals from each of secondary ambient light sensors 52 in sequence (e.g., starting with a first of sensors 52, proceeding to a second of sensors 52, and so forth).

Initially, for example, storage and processing circuitry 30 may be used in step 100 to gather touch sensor data or other proximity sensor data to determine whether or not a first of sensors 52 has been shadowed. Each of sensors 52 may, for example, be located adjacent to a different respective capacitive touch sensor electrode such as one of electrodes 50 of FIG. 3. By gathering touch sensor electrode data from the electrode that is in the vicinity of the first ambient light sensor 52, storage and processing circuitry 30 may determine whether an external object such as object 76 of FIG. 3 is located in the vicinity of the first ambient light sensor 52. If sensor data from electrode 50 (e.g., a touch screen display data) or other proximity sensor equipment indicates that external object 76 is present near the first of ambient light sensors 52, storage and processing circuitry 30 can conclude that the first ambient light sensor is likely shadowed by the external object. Because the first ambient light sensor is likely shadowed and is not able to produce accurate ambient light sensor readings, processing may proceed to the next (e.g., the second) ambient light sensor, as indicated by step 102 of FIG. 7.

Whenever touch sensor data or other sensor data indicates that the secondary ambient light sensor 52 that is being examined is not being shadowed, storage and processing circuitry 30 may store data (e.g., digital data) for the ambient light sensor reading from that ambient light sensor 52 in volatile memory or other storage within storage and processing circuitry 30 (step 104).

During the operations of step 106, storage and processing circuitry 30 may be used to determine whether to evaluate readings from additional secondary ambient light sensors 52. If, for example, it is desired to obtain readings from each of the six secondary ambient light sensors shown in FIG. 5 and ambient light sensor data from fewer than six ambient light sensor readings has been examined, device 10 may use storage and processing circuitry 30 to gather an ambient light sensor reading from an additional one of ambient light sensors 52 (steps 102, 100, and 104).

Once ambient light sensor readings have been obtained from all unshadowed secondary ambient light sensors (or other desired set of secondary ambient light sensors), the secondary ambient light sensor data may be processed (step 108) to produce a corresponding processed secondary ambient light sensor data reading. Examples of data processing techniques that may be used in processing the secondary ambient light sensor data include calculating an average of all unshadowed data readings, discarding one or more abnormally low readings (e.g., discarding readings that fall below a user-defined or default threshold value), discarding one or more abnormally high readings (e.g., discarding readings that are above a user-defined or default threshold value that is indicative of faulty sensor performance), computing an arithmetic or geometric mean, using a given number of the largest readings, curve fitting, using only the single highest reading, averaging the top several measured ambient light sensor values, or otherwise processing the ambient light sensor data from secondary ambient light sensors 52.

Secondary ambient light sensors 52 may not include optical filters or other structures for ensuring that secondary ambient light sensors 52 have a human-eye response. Accordingly, it may be desirable to include at least some ambient light sensor readings from a human-eye-response sensor such as primary ambient light sensor 82 of FIG. 5. As shown in FIG. 7, ambient light sensor data from primary ambient light sensor 82 may be gathered at step 110.

At step 112, the processed ambient light sensor data from secondary ambient light sensors 52 (ambient light sensor data NC) may be compared to the ambient light sensor data from primary ambient light sensor 82 (ALS). Any suitable processing scheme may be used to compare the values of NC and ALS (e.g., schemes that compute a weighted difference between NC and ALS and compare this value to a threshold, etc.).

Primary ambient light sensor 82 may include first and second sensor elements each of which has a different spectral response. Sensor 82 may, for example, gather data from a first sensor element that is responsive to visible and infrared light (sensor element reading D1) and may gather data from a second sensor element that is responsive to infrared light only (sensor element reading D2). By computing the value of D1−K*D2, where K is a calibration factor, human-eye-response (visible light) readings may be produced. To enhance accuracy in a variety of lighting conditions, device 10 may vary the value of K as a function of different operating environments. For example, if the amount of ambient infrared light is high (e.g., if D2/D2 is measured to be greater than 0.5), the value of K may be set to a first value K1, whereas the value of K may be set to a second value of K2 when the amount of detected ambient infrared light is low.

In comparing NC to ALS during the operations of step 112, device 10 may use storage and processing circuitry 30 to set the value of ALS equal to D1−K*D2, using an appropriate K value and may compute the difference between NC and ALS.

If the magnitude of ALS is significantly lower than NC (e.g., if ALS is less than 10% of NC, if ALS is less than 25% of NC, or is less than another predetermined fraction of NC), storage and processing circuitry 30 can conclude that the primary sensor is shadowed. The predetermined fraction of NC that is used in determining whether the magnitude of ALS is significantly lower than NC may be established during a factory calibration procedure or may be determined as part of a periodic dynamic calibration procedure. Storage and processing circuitry 30 may then use the processed secondary ambient light sensor data that was produced during the operations of step 108 to adjust display brightness or may take other suitable actions based on the processed secondary ambient light sensor data (step 120).

If, however, the magnitude of ALS is not significantly lower than NC (e.g., if ALS is not less than 10% of NC, is not less than 25% of NC, etc.), storage and processing circuitry 30 can conclude that primary ambient light sensor 82 is not shadowed and is producing an accurate ambient light sensor reading.

When the main sensor reading is reliable, storage and processing circuitry 30 may calibrate secondary ambient light sensors 52 by using the primary ambient light sensor data as a calibration reference value during the operations of step 114. If desired, an initial calibration value for sensors 52 may be stored in storage and processing circuitry 30 based on a set of calibration measurements made during manufacturing (e.g., by performing tests on device 10 and loading default settings into device 10 in a factory). The calibration operations of step 114 may be performed to dynamically update the calibration of the secondary light sensors and thereby prevent errors due to long term drift. The calibration operations of step 114 may, if desired, involve calibration of the value of the predetermined fraction of NC that is used in determining whether the magnitude of ALS is significantly lower than NC.

Following calibration operations at step 114, storage and processing circuitry 30 may use the primary ambient light sensor data that was gathered during the operations of step 110 to adjust display brightness or take other suitable actions based on the processed secondary ambient light sensor data (step 120).

The foregoing is merely illustrative of the principles of this invention and various modifications can be made by those skilled in the art without departing from the scope and spirit of the invention.

1. (canceled)

2. A display having an active; area and an inactive area, the display comprising:
a display cover layer;
an opaque masking layer formed on an inner surface of the display cover layer in the inactive area;
an array of pixels that emit light through the display cover layer in. the active area; and
a touch sensor having a first portion with touch sensor electrodes in the active area of the display and a second portion with at least one additional touch sensor electrode in the inactive area of the display, wherein the second portion of the touch sensor extends under the opaque masking layer.

3. The display defined in claim 2 wherein the: touch sensor electrodes and the at least one additional touch sensor electrode comprise capacitive touch sensor electrodes.

4. The display defined in claim 2 wherein the opaque masking layer has an opening in the inactive area to accommodate an ambient light sensor and wherein the touch sensor detects touches in the inactive area surrounding the ambient light sensor.

5. The display defined in claim 2 wherein the touch sensor is interposed between the display cover layer and the array of pixels.

6. The display defined in claim 2 wherein the touch sensor electrodes and the at least one additional touch sensor electrode are formed on a common substrate.

7. The display defined in claim 2 wherein the active area has first and second opposing edges, wherein the opaque masking layer has a first portion that shares a border with the active area along the first edge and a second portion that shares a border with the active area along the second edge, and wherein the second portion of the touch sensor extends under both the first and second portions of the opaque masking layer.

8. An electronic device, comprising:
an array of display pixels;
an ambient light sensor;
an array of touch sensor electrodes including a first touch sensor electrode that detects touch events over the array of display pixels and a second touch sensor electrode that detects touch events over the ambient light sensor; and
control circuitry that controls operation of the display pixels based on signals from the first touch sensor electrode and that determines whether the ambient light sensor is shadowed based on signals from the second touch sensor electrode.

9. The electronic device defined in claim 8 wherein first and second touch sensor electrodes each comprise a capacitive touch sensor electrode.

10. The electronic device defined in claim 9 wherein the capacitive touch sensor electrode comprises indium tin oxide.

11. The electronic device defined in claim 9 wherein the array of display pixels and the ambient light sensor are formed on a substrate.

12. The electronic device defined in claim 11 wherein the array of touch sensor electrodes is formed on a touch sensor substrate, wherein the first touch sensor electrode is formed on a first portion of the touch sensor substrate and the second touch sensor electrode is formed on a second portion of the touch sensor substrate, wherein the first portion of the substrate overlaps the array of display pixels, and wherein the second portion of the touch sensor substrate overlaps the ambient light sensor.

13. The electronic device defined in claim 8 further comprising an additional ambient light sensor, wherein the control circuitry controls a brightness level of the display pixels based on signals from the additional ambient light sensor when the ambient light sensor is shadowed.

14. The electronic device defined in claim 13 further comprising an opaque masking layer that at least partially covers the second touch sensor electrode.

15. An electronic device having a display, wherein the display includes an active area and an inactive area, the electronic device comprising:
a display cover layer;
an opaque masking layer formed on ah inner surface of the display cover layer in the inactive area, wherein the opaque masking layer has first and second openings;
a first ambient light sensor mounted in alignment with the first opening and a second ambient light sensor mounted in alignment with the second opening;
an array of pixels that emit light through the display cover layer in the active area;
an array of touch sensor electrodes including a first touch sensor electrode that detects touch events in the inactive area adjacent to the first ambient light sensor, a second touch sensor electrode that detects touch events in the inactive area adjacent to the second ambient light sensor, and a third touch sensor electrode that detects touch events in the active area; and
control circuitry that determines whether the first ambient light sensor is shadowed based on signals from the first touch sensor electrode and that adjusts a brightness level of the array of pixels based on signals from the second ambient light sensor when the first ambient light sensor is shadowed.

16. The electronic device defined in claim 15 wherein the first and second ambient light sensors each comprise a light sensor selected from the group consisting of: a nanocrystal silicon light sensor having clumps of silicon in a silicon dioxide layer, an amorphous silicon light sensor, and a polysilicon light sensor.

17. The electronic device defined in claim 15 wherein the first and second ambient light sensors and the array of pixels are formed on a substrate.

18. The electronic device defined in claim 17 wherein the substrate comprises a thin-film-transistor substrate.

19. The electronic device defined in claim 15 wherein the array of touch sensor electrodes comprises indium tin oxide.

20. The electronic device defined in claim 15 wherein the opaque masking layer at least partially covers the first and second touch sensor electrodes.

21. The electronic device defined in claim 15 wherein the array of touch sensor electrodes are formed on a touch sensor substrate having a first portion that overlaps the active area and a second portion that overlaps the inactive area.
